(19) United States
(12) Patent Application Publication
(10) Pub. No.: US 2024/0385299 A1
(43) Pub. Date: Nov. 21, 2024

(54) FIELD-SELECTABLE DYNAMIC GAIN CONTROL MODES OF OPTICAL SENSORS

(71) Applicant: BANNER ENGINEERING CORP., Minneapolis, MN (US)

(72) Inventor: Ashley Wise, Plymouth, MN (US)

(73) Assignee: BANNER ENGINEERING CORP., Minneapolis, MN (US)

(21) Appl. No.: 18/692,628

(22) PCT Filed: Sep. 16, 2022
(86) PCT No.: PCT/US2022/076604

§ 371 Date: Mar. 15, 2024

Related U.S. Application Data
(60) Provisional application No. 63/261,311, filed on Sep. 17, 2021.

(51) Int. Cl. G01S 7/489; G01S 7/4865; G01S 7/497; G01S 17/10

(52) U.S. Cl. CPC G01S 7/489; G01S 7/4865; G01S 7/497; G01S 17/10

(57) ABSTRACT

Apparatus and associated methods relate to a field selectable gain mode system. In an illustrative example, an APD-based sensor may, for example, have two or more predetermined gain modes. The gain modes may, for example, be activated in response to a selection signal(s) generated by a user. For example, the APD-based sensor may apply the user-selected gain mode by independently controlling a circuit gain, an emitter gain, and an APD gain. When the user selection signal is selected, for example, a controller may apply corresponding independent gain parameters to the circuit gain, the emitter gain, and the APD gain, such that a collective high dynamic range sensor system is provided. For example, the independent gain parameters may include a range of control voltages, a range of control current, and/or a range of gain input. Various embodiments may advantageously achieve increased accuracy across an extended operating range of gain values.

### CROSS-REFERENCE TO RELATED APPLICATIONS

This application claims the benefit of U.S. Provisional Application Ser. No. 63/261,311, titled “Field-Selectable Dynamic Gain Control Modes of Optical Sensors,” filed by Ashley Wise on Sep. 17, 2021.

This application incorporates the entire contents of the foregoing application(s) herein by reference.

The subject matter of this application may have common inventorship with and/or may be related to the subject matter of the following:
U.S. application Ser. No. 15/625,949, titled “Open-Loop Laser Power-Regulation,” filed by Ashley Wise on Jun. 16, 2017, and issued as U.S. Pat. No. 9,985,414 on May 29, 2018;
U.S. Application Serial No. PCT/US21/71304, titled “Open-Loop Photodiode Gain Regulation,” filed by Ashley Wise, et al., on Aug. 27, 2021;
U.S. Application Ser. No. 63/107,311, titled “Frequency Domain Opposed-Mode Photoelectric Sensor,” filed by David S. Anderson, et al., on Oct. 29, 2020;
U.S. application Ser. No. 17/036,255, titled “Near Range Radar,” filed by Ashley Wise, et al., on Sep. 29, 2020;
U.S. Application Ser. No. 62/924,025, titled “Near Range Radar,” filed by Ashley Wise, et al., on Oct. 21, 2019;
U.S. application Ser. No. 17/446,142, titled “Open-Loop Photodiode Gain Regulation,” filed by Ashley Wise, et al., on Aug. 26, 2021; and
U.S. Application Ser. No. 63/071,080, titled “Open-Loop Photodiode Gain Regulation,” filed by Ashley Wise, et al., on Aug. 27, 2020.

This application incorporates the entire contents of the foregoing application(s) herein by reference.

### TECHNICAL FIELD

Various embodiments relate generally to gain control.

### BACKGROUND

Photodiodes, including avalanche photodiodes (APDs), are employed in a range of applications. Applications may include, but are not limited to, presence and positioning in photoelectric sensors, distance measurement in triangulation and time of flight sensors, and fiber-optic communication.

In some examples, accuracy of distance measurement using APDs may be affected by reflectivity and distance of a target object. In some examples, a sensitivity of the distance measurement may also be affected by environmental parameters such as temperature and ambient light. Therefore, calibration may sometimes be applied to adjust a distance sensor according to a measurement environment.

### SUMMARY

Apparatus and associated methods relate to a field selectable gain mode system. In an illustrative example, an APD-based sensor may, for example, have two or more predetermined gain modes. The gain modes may, for example, be activated in response to a selection signal(s) generated by a user. For example, the APD-based sensor may apply the user-selected gain mode by independently control a circuit gain, an emitter gain, and an APD gain. When the user selection signal is selected, for example, a controller may apply corresponding independent gain parameters to the circuit gain, the emitter gain, and the APD gain, such that a collective high dynamic range sensor system is provided. For example, the independent gain parameters may include a range of control voltages, a range of control current, and/or a range of gain input. Various embodiments may advantageously achieve increased accuracy across an extended operating range of gain values.

Various embodiments may achieve one or more advantages. For example, some embodiments may further generate a measurement offset profile based on the user-selected gain mode to advantageously maintain a high accuracy of measurement independent of the user-selected gain mode. Some embodiments may, for example, advantageously improve gain adjustment delays by comparing an updated set of gain parameters to an original set of gain parameters so that only the gain parameters with changes are applied. Some embodiments may, for example, generate at least one of the user-selectable gain modes based on a measured environmental parameter to advantageously maintain measurement accuracy according to the measured environmental parameter.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary selectable dynamic gain mode sensor (SDGMS) employed in an illustrative use-case scenario.

FIG. 2 depicts a block diagram of an exemplary SDGMS system.

FIG. 3 depicts an electrical block diagram of an exemplary SDGMS system.

FIG. 4 depicts an exemplary limited dynamic range window which may be expanded by exemplary SDGMS systems.

FIG. 5 depicts an exemplary set of nominal user selectable gain mode levels.

FIG. 6 depicts an exemplary amplitude plot of an exemplary high-reflectivity (HR) gain mode of an exemplary SDGMS.

FIG. 7 depicts an exemplary amplitude plot of an exemplary low-reflectivity (LR) gain mode of an exemplary SDGMS.

FIG. 8 depicts an exemplary SDGMS system control method.

FIG. 9A and FIG. 9B depict an exemplary user interface interaction process to field-adjust a first channel of an exemplary SDGMS.

FIG. 10 depicts an exemplary user interface interaction process to field-adjust a second channel of the exemplary SDGMS.

Like reference symbols in the various drawings indicate like elements.

### DETAILED DESCRIPTION OF ILLUSTRATIVE EMBODIMENTS

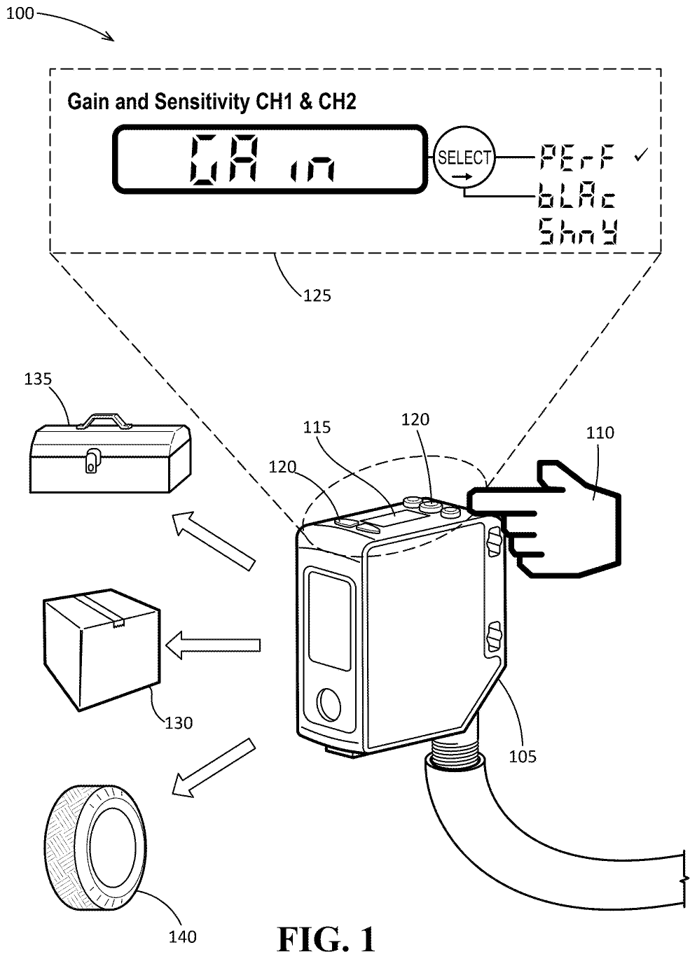

FIG. 1 depicts an exemplary selectable dynamic gain mode sensor (SDGMS) employed in an illustrative use-case scenario. In an exemplary scenario 100, an SDGMS 105 may be operated by a user 110 into a desired gain mode. The SDGMS 105 may have a user interface including a display 115. The interface may include user input elements 120 (e.g., buttons). The user 110 may operate the user input elements 120 as shown in an exemplary interface display 125 to selectively operate the SDGMS 105 into a predetermined dynamic gain mode. As depicted, by way of example and not limitation, the dynamic gain mode may include performance (“PErF”), low-reflectivity (LR) gain mode (“bLAc”), and high-reflectivity (HR) gain mode (“ShnY”). In some embodiments the performance mode may, by way of example and not limitation, be a default mode.

The user 110 may, for example, operate the SDGMS 105 into a gain mode appropriate for a target object. The SDGMS 105 may, for example, be configured as a distance sensor. The user 110 may select the HR gain mode when using the SDGMS 105 to detect the distance to a highly reflective target, such as a shiny metal target 135 (e.g., a polished metal toolbox). The user 110 may select the performance (e.g., ‘normal’ gain) when using the SDGMS 105 to detect the distance to a normally reflective target, such as a cardboard box 130. The user 110 may select the LR gain mode when using the SDGMS 105 to detect the distance to a minimally reflective target, such as a black rubber tire 140. Accordingly, in various embodiments the SDGMS 105 may advantageously be field adjusted into one of multiple (predetermined) dynamic gain modes according to a (currently) intended application.

Each (predetermined) dynamic gain mode may correspond to one or more predetermined settings. For example, when the SDGMS 105 is operated into a predetermined gain mode, a control unit of the SDGMS 105 may apply a predetermined gain mode profile to various hardware and/or software parameters. The gain mode profile may, for example, include emitter power parameter(s). The gain mode profile may, for example, include receiver drive control (e.g., drive voltage, drive current) parameters. The gain mode profile may, for example, include at least one calibration profile. The calibration profile may, for example, include temperature calibration. The calibration profile may, for example, include voltage calibration. A predetermined gain mode may, for example, advantageously optimize the SDGMS 105 for a predetermined operation mode. Within a predetermined gain mode, the SDGMS 105 may advantageously dynamically adjust gain within a (predetermined) range. The dynamic gain range may, for example, be determined as a function of the gain mode profile.

For example, APDs may be used in a myriad of applications. APDs may, by way of example and not limitation, include single-photon avalanche diodes (SPAD). APDs may, for example, include silicon photomultipliers (SiPM). In some embodiments, APDs may include, for example, multi-pixel photon-counters (MPPC).

In various embodiments APDs may, for example, be applied to presence measurement. APDs may, for example, be applied to distance measurement. In some embodiments a system including an APD(s) may be configured as a time-of-flight sensor. In some embodiments, APDs may, for example, be used in fiber-optic communication implementations.

APDs may, for example, operate at a high reverse bias voltage. The reverse bias voltage may, by way of example and not limitation, include a range from 20 to 200 volts.

APDs may, for example, provide a current gain of a photoelectrical current on the order of Unity to 100s of times. When operated in Geiger mode, APD gain can, for example, be thousands to millions. In some embodiments, for example, current gain of an APD may be embedded with the photodetector. Such embodiments may, for example, advantageously provide improved signal-to-noise ratio relative to a photodetector with an external gain (such as a trans-impedance amplifier (TIA)). In some embodiments, a TIA(s) may be implemented to gain an output of an APD.

APD gain may be proportional to the reverse bias voltage. If the reverse bias voltage is too low, the APD may not operate at all. If the reverse bias voltage is too high, the APD may enter Geiger mode (which may be unstable). Accordingly, various embodiments may adjust the APD gain up and down to accommodate a wide range of light intensity hitting the APD. Adjusting the gain of an APD may, for example, be accomplished by adjusting the reverse bias voltage. In some embodiments a time for (dynamic) APD gain adjustment to settle may be large. For example, in some embodiments a large APD gain adjustment time may be up to 250 ms. For example, to switch from 100× gain to 10× gain, in some embodiments, may require waiting hundreds of milliseconds for the gain change to take effect. In some applications, however, photoelectric sensors may be required to operate with response speeds on the order of 250 us to 5 ms. Therefore, a large APD gain adjustment time may be too slow to happen during run mode operation without disrupting the sensor response time.

Various embodiments may advantageously operate the APD gain into a predetermined gain mode corresponding to a (limited) dynamic range. The output gain of the APD may, for example, be adjusted in the dynamic range. The APD may, for example, operate at a predetermined reverse bias voltage based on the currently selected gain mode. The APD may, for example, operate in a restricted reverse bias voltage range corresponding to a (predetermined) maximum response time and based on the currently selected gain mode. Accordingly, various embodiments may advantageously provide a wide gain range while achieving fast response times.

Dynamic range of light intensity hitting a photodiode (e.g., an APD) may be quite large. In some systems, for example, light may be emitted by a light emitting element (e.g., laser, vertical-cavity surface-emitting laser (VCSEL), edge emitting laser (EEL), LED), be reflected off a target, and a portion of this reflected light, including a diffuse component and a specular component, may be received on the APD.

In some embodiments, the SDGMS 105 may be configured with a gain mode corresponding to “normal” targets having a reflectivity, by way of example and not limitation, between 3% to 90% diffuse reflection, with negligible specular reflection. However, many applications may demand sensing of a wider range of targets, such as, for example, including clear and high-angles (0.1%) and partially specular (1000%). This exemplary range of reflectivity may represent a 1:10000 dynamic range. Fully specular targets such as mirrors and retro-reflectors may, for example, require a dynamic range of 1:100000 or more.

Light intensity decreases by 1/D² (where D=distance). Accordingly, a low-reflectivity target that requires 1:10000 dynamic range at distance D may require a dynamic range of 1:250000 at a second distance=5*D.

A dynamic range of an electronic circuit may, for example, be required to match a needed dynamic range of intended target(s). The dynamic range of the electronic circuit may, for example, be measured relative to a noise floor and/or baseline. This baseline/noise floor may, for example, be a minimum operating level (e.g., voltage, current, ADC value) at which a signal can be adequately distinguished from noise.

The dynamic range of an electronic circuit may, for example, be limited at an upper end by saturation. When a voltage, current, and/or ADC input is above a threshold, the circuit may be saturated, and the input cannot be measured any further. For a given electronic circuit configuration, a dynamic range may, for example, include saturation divided by noise floor.

For a given electronic circuit configuration, a ratio of saturation to noise floor may, by way of example and not limitation, be between 1:50 to 1:200. In order to meet a 1:10000 minimum dynamic range, for example, the circuit dynamic range may require being scaled by changes in gain. Increasing gain by a factor of 10, for example, could provide a dynamic range of 1:500 to 1:2000 by gain change. In various embodiments, this principle may, for example, advantageously be applied to provide a circuit with a desired dynamic range (e.g., greater than the example, lesser than the example).

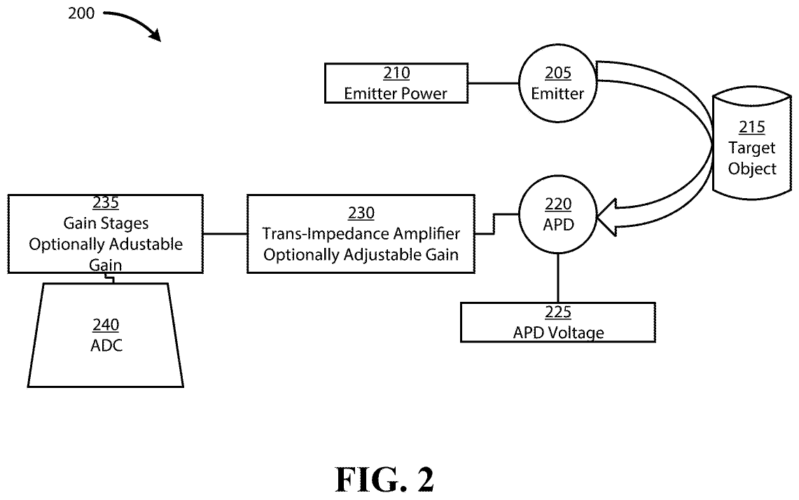

FIG. 2 depicts a block diagram of an exemplary SDGMS system. In the depicted exemplary SDGMS system 200, an emitter 205 is controlled by an emitter power module 210. In the illustrative depicted example, the emitter power module may, by way of example and not limitation, adjust emitter power by changing current to a laser. The emitter power module may, for example, provide between a 1:5 to 1:20 dynamic range in emitter power. In various examples, the emitter 205 may emit a signal (e.g., electromagnetic signal) towards a target object 215. The emitter 205 may, for example, include a photoelectronic emitter. The emitter 205 may, for example, include a laser and the emitted signal may include an optical beam(s). The emitter 205 may, for example, include an LED. The emitter 205 may, for example, emit a pulsed signal. The pulsed signal may, for example, be clocked. A monitor photodiode may, for example, measure characteristic(s) of the emitted signal.

A receiver may, for example, receive a reflection of the emitted signal reflected off of the target object 215. The receiver may, for example, include a photodetector. The photodetector may, as depicted, include an avalanche photodiode (APD 220). The APD 220 is driven by an APD voltage 225 (e.g., reverse bias voltage). The APD voltage 225 may, for example, represent a dynamic gain range from 1:1 to 1:20, as depicted.

In the depicted example, electronic circuit gain is applied to an output (e.g., voltage, current) of the APD 220. As depicted, the electronic circuit gain may be provided by a trans-impedance amplifier (TIA 230). The TIA 230 may, for example, be implemented to adjust a gain of the output of the APD 220.

In the depicted example, electronic circuit gain may be provided by a gain stage(s) (e.g., operational amplifier gain stage(s)) circuit(s) (gain stages 235). The stages 235 may, for example, be implemented to adjust the gain of the output of the APD 220. In some embodiments the stages 235 may operate directly on an output of the APD 220. In some embodiments the stages 235 may, for example, operate on an output of the TIA 230. The electronic circuit gain (e.g., the TIA 230 and/or the stages 235) may, for example, provide between 1:5 to 1:20 dynamic range in adjustable gain.

An analog to digital converter (ADC 240) circuit may, as depicted, operate on an output of the stages 235. The ADC 240 may, for example, operate on an output of the TIA 230. The ADC 240 may, for example, provide between 1:50 to 1:200 dynamic (gain) range relative to a noise floor of the signal.

Altogether, at an upper end, the depicted exemplary SDGMS system 200 may have an 1:80000 dynamic range in the depicted gain mode. In some embodiments the gain mode may, for example, be adjustable. Some embodiments may, for example, increase this dynamic range further. Various embodiments may, for example, advantageously enable a single sensor system to see dark targets (e.g., 0.1% reflectivity) at long distances and highly reflective targets (e.g., 1000% reflectivity) at close distance ranges. Various such embodiments may, for example, account for an additional 1/D² factor (where D=distance to a target) of target intensity versus distance.

Various embodiments may, for example, provide both emitter gain control and circuit gain control to advantageously enable wide dynamic range while maintaining fast response speeds. Some embodiments may, for example, increase dynamic range (e.g., greater than 1:80000) by another order of magnitude. For example, a combination of circuit gain control and emitter gain control (e.g., by selectable gain modes) may advantageously provide in some embodiments, by way of example and not limitation, between 5× and 100× more gain. Such embodiments may, for example, allow a user selectable APD gain mode that optimizes the electronic circuit and software for two or more gain modes. Accordingly, various embodiments may advantageously provide predetermined gain modes to increase effective gain range of a single sensor across multiple gain modes that would otherwise be too slow to be performed strictly during run mode while maintaining fast response speeds.

In various embodiments selectable gain modes may be associated with (predetermined) calibration profiles. For example, various embodiments may advantageously maintain measurement accuracy for all selectable gain modes. Various embodiments may advantageously maintain consistent gain levels over a wide temperature range. For example, some embodiments may advantageously maintain consistent gain levels over −10° C. to +50° C.

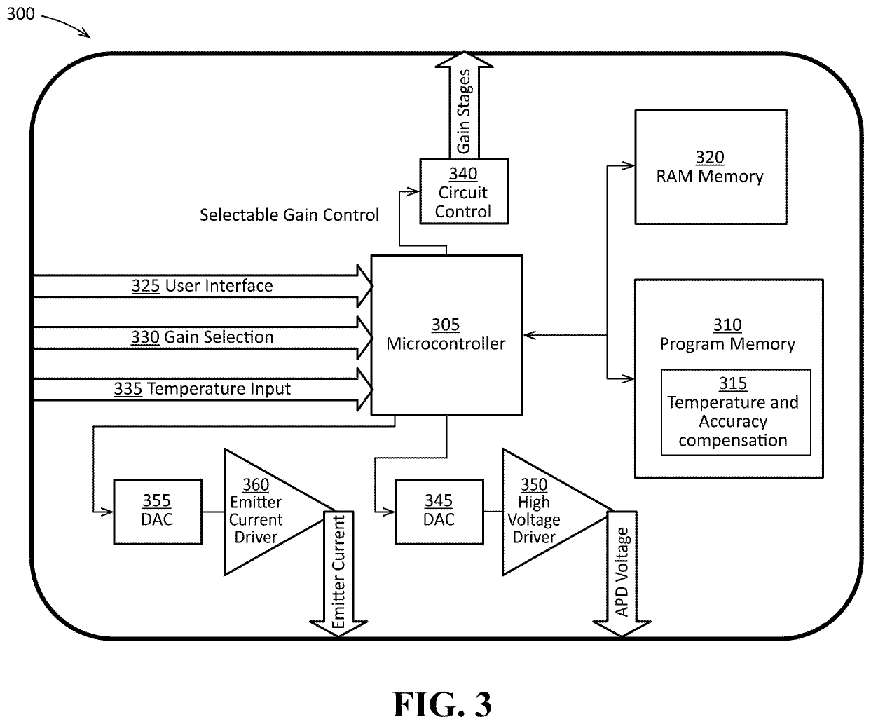

FIG. 3 depicts an electrical block diagram of an exemplary SDGMS system. An SDGMS 300 includes a processor 305 (e.g., “microcontroller,” as depicted). The processor 305 is operably coupled to a random-access memory module (RAM 320). The processor 305 is operably coupled to a program memory module 310 (e.g., non-volatile memory).

In the depicted example, the program memory module 310 includes a temperature and accuracy compensation memory module (TACMM 315). The TACMM 315 may, for example, include (predetermined) temperature calibration profiles. The TACMM 315 may, for example, include (predetermined) accuracy calibration profiles. The calibration profiles may, for example, be specific to a sensor. The calibration profiles may, for example, be specific to a family of sensors. The calibration profiles may, for example, include parameters. The calibration profiles may, for example, be embodied in the form of one or more lookup tables (LUTs). The calibration profiles may, for example, include one or more predetermined calibration relationships (e.g., equations).

The processor 305 is operably coupled to a user interface 325. The processor 305 may, for example, receive signal(s) from and/or transmit signal(s) to a user via the user interface 325. For example, a user may operate the user interface 325 to provide a signal(s) to the processor 305 to select a (predetermined) gain mode. The processor 305 receives a gain selection signal 330. The gain selection signal 330 may, for example, be received via the user interface 325 in response to operation by a user. The processor 305 further receives a temperature input signal 335, in the depicted example. The processor 305 may, for example, retrieve a calibration profile(s) from the TACMM 315 in response to the gain selection signal 330 and/or the temperature input signal 335.

The processor 305 may, for example, retrieve a gain mode profile(s) from the program memory module 310 in response to the gain selection signal 330.

The processor 305 is further operably coupled to a circuit control 340. The circuit control 340 outputs control signal(s) to gain stage(s) (e.g., gain stages 235). The gain stages may, for example, operate on an output of an APD.

The processor 305 is further operably coupled to a digital to analog converter module 345 (“DAC”). The converter module 345 provides a signal to a high voltage driver 350. The converter module 345 may, for example, provide the signal(s) to the high voltage driver 350 in response to signal(s) from the processor 305 generated as a function of a gain selection mode. The high voltage driver 350 generates an APD voltage (e.g., drive voltage, reverse bias voltage) in response to the signal(s) received from the converter module 345.

The processor 305 is operably coupled to a converter module 355 (“DAC”). The converter module 355 is operably coupled to an emitter current driver 360. The converter module 355 may, for example, generate a signal(s) for the emitter current driver 360 in response to a currently selected gain mode profile. The emitter current driver 360 generates an emitter current (e.g., to drive the emitter 205). The emitter current driver 360 may, for example, generate the emitter current in response to the signal(s) from the converter module 355.

Accordingly, various embodiments may advantageously achieve gain control through a combination of emitter gain control (e.g., via converter module 355 and/or emitter current driver 360), APD (receiver) gain control (e.g., via converter module 345 and/or high voltage driver 350), and/or electronic circuit control (e.g., circuit control 340). The SDGMS 300 may, for example, dynamically operate in a limited dynamic gain range, within a broader gain range the sensor is capable of operating in, in response to a currently selected gain mode. Accordingly, various embodiments may advantageously achieve fast response times across an expanded operating range of gain values.

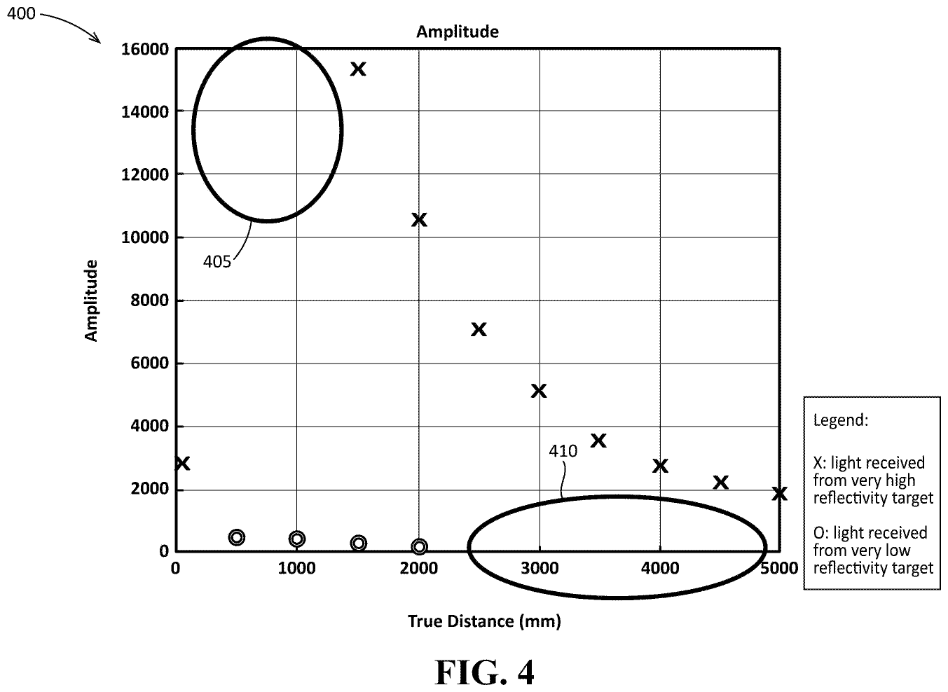

FIG. 4 depicts an exemplary limited dynamic range window which may be expanded by exemplary SDGMS systems. A plot 400 depicts amplitude vs true distance (mm) in a single gain mode. For example, amplitude may be approximately (1/distance²). The plot 400 may, for example, represent a ‘normal’ gain mode. The plot 400 may, for example, represent a sensor without selectable gain ranges.

In the depicted example, a signal received from a very high reflectivity target (e.g., ≥1000%) at a minimum gain level at close range (e.g., <1500 mm) may exceed a saturation threshold of the sensor, as shown by the ‘x’ data points in the plot 400. In an area 405, light received from the very high reflective target may be above saturation at minimum gain at close range. A signal received from a very low reflective target (e.g., ≤0.1%) at a maximum gain level at a far range (e.g., >2000 mm) may be below a noise floor of the sensor, as shown by the ‘o’ data points in the plot 400. In an area 410, the light received from the very low reflectivity target may be below noise floor at maximum at far range.

In a given gain mode, for example, even at minimum gain levels, a highly reflective target may still be above saturation at close range. In a given gain mode, even at maximum gain levels, a very low reflectivity target may still be below the noise floor at farther ranges.

Various embodiments may advantageously provide user selectable gain modes that adjust the APD gain to a (predetermined) operating value. Various embodiments may advantageously provide user selectable gain modes that adjust the APD gain into a (predetermined) operating range. For example, some embodiments may advantageously provide additional adjustment of 1:1 to 1:20. Such embodiments may, for example, advantageously increase dynamic range of the system (e.g., as disclosed at least with reference to FIGS. 2-3) to around 1:1000000.

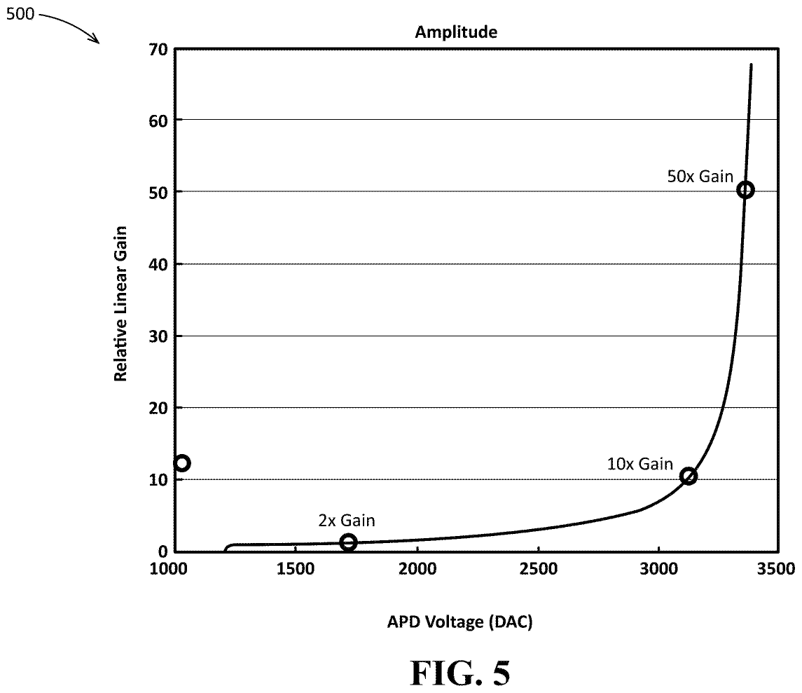

FIG. 5 depicts an exemplary set of nominal user selectable gain mode levels. The plot 500 represents an example of three user selectable gain levels. For example, 2× gain (e.g., of the APD) may correspond to an HR mode. As depicted, 10× gain may, for example, correspond to a ‘normal’ (e.g., ‘performance’) mode. As depicted, a 50× gain may, for example, correspond to an LR mode.

Various embodiments may, for example, be provided with predetermined gain mode levels in a geometric series relative to one another. For example, each gain mode may be a (predetermined) multiple (e.g., 5× as depicted) of the preceding gain mode. In some embodiments, for example, a normal gain mode may be selected in a transition between to substantially linear sections of a relative linear gain vs APD voltage relationship.

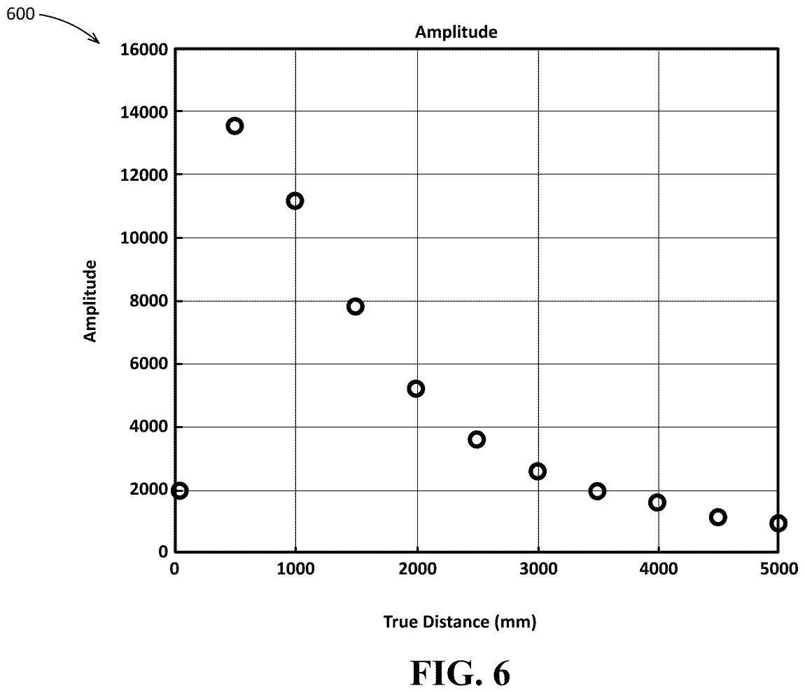

FIG. 6 depicts an exemplary amplitude plot of an exemplary high-reflectivity (HR) gain mode of an exemplary SDGMS. A plot 600 may, for example, represent amplitude vs true distance in an HR gain mode. The gain mode may, for example, correspond to an APD gain of 2X (e.g., as disclosed at least with reference to FIG. 5). In the depicted example, with a lower APD gain, a highly reflective target at minimum gain is below saturation level.

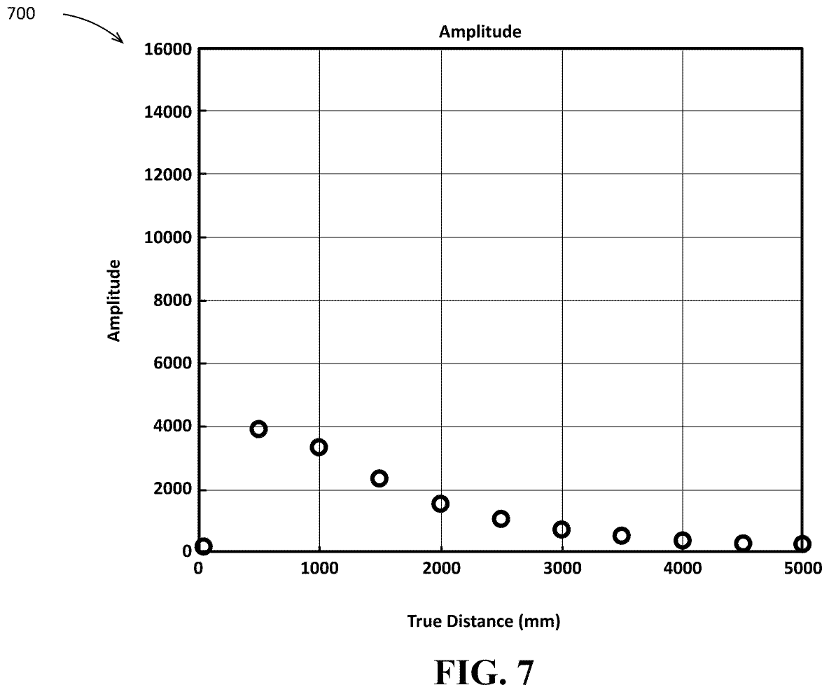

FIG. 7 depicts an exemplary amplitude plot of an exemplary low-reflectivity (LR) gain mode of an exemplary SDGMS. A plot 700 may, for example, represent amplitude vs true distance in an LR gain mode. The gain mode may, for example, correspond to an APD gain of 50X (e.g., as disclosed at least with reference to FIG. 5). In the depicted example, with a higher APD gain, a very low reflectivity target at maximum gain is above the noise floor.

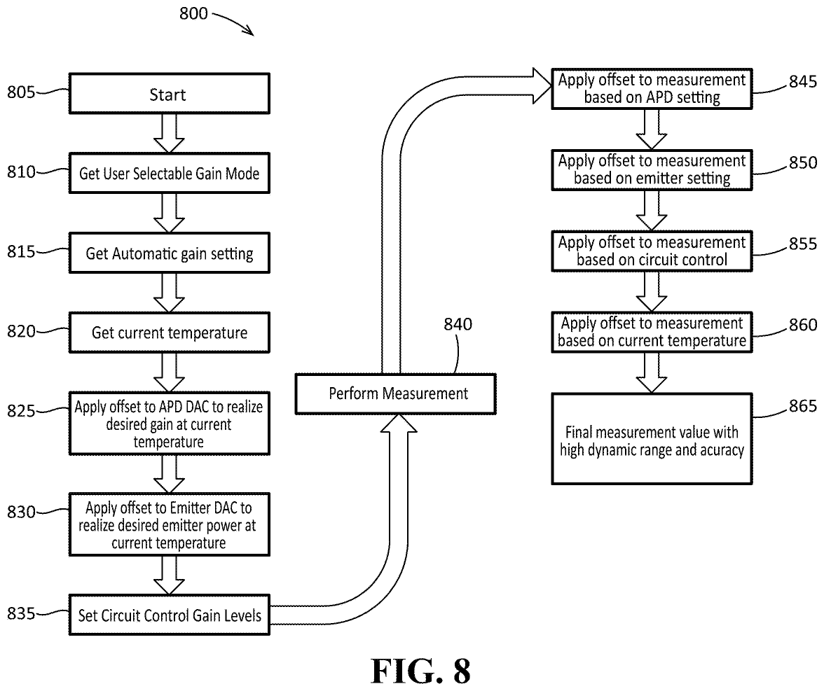

FIG. 8 depicts an exemplary SDGMS system control method. A method 800 may, for example, be performed by the processor 305 executing instructions stored in the program memory module 310. The method 800 starts 805 and gets 810 a user selectable gain mode (e.g., corresponding to a current value based on input from a user interface). An automatic gain setting corresponding to the gain mode is retrieved 815. A current temperature is retrieved 820 (e.g., from a temperature sensor). An offset is generated (e.g., retrieved, calculated) and applied to the APD DAC in a step 825 to realize a desired gain at the current temperature. An offset is applied 830 to an emitter DAC to achieve a desired emitter power at the current temperature. Circuit control gain levels are set 835.

Measurement (e.g., corresponding to a signal received by an APD) is performed 840.

An offset is applied 845 to the measurement based on the current APD setting. An offset is applied to 850 to the measurement based on the emitter setting. An offset is applied 855 to the measurement based on the circuit control. An offset is applied 860 to the measurement based on the current temperature (e.g., as calibrated in response to the current gain mode). A final measurement value is generated 865. The final measurement may, for example, advantageously have high accuracy across a wide dynamic range.

In various embodiments, offsets to improve accuracy due to gain settings and temperature may, for example, be computed on an individual basis. In various embodiments, offsets to improve accuracy due to gain settings and temperature may, for example, be computed on a family basis. The offsets may be implemented, for example, as direct values. The offsets may be implemented, for example, as LUTs. The offsets may be implemented, for example, as equations.

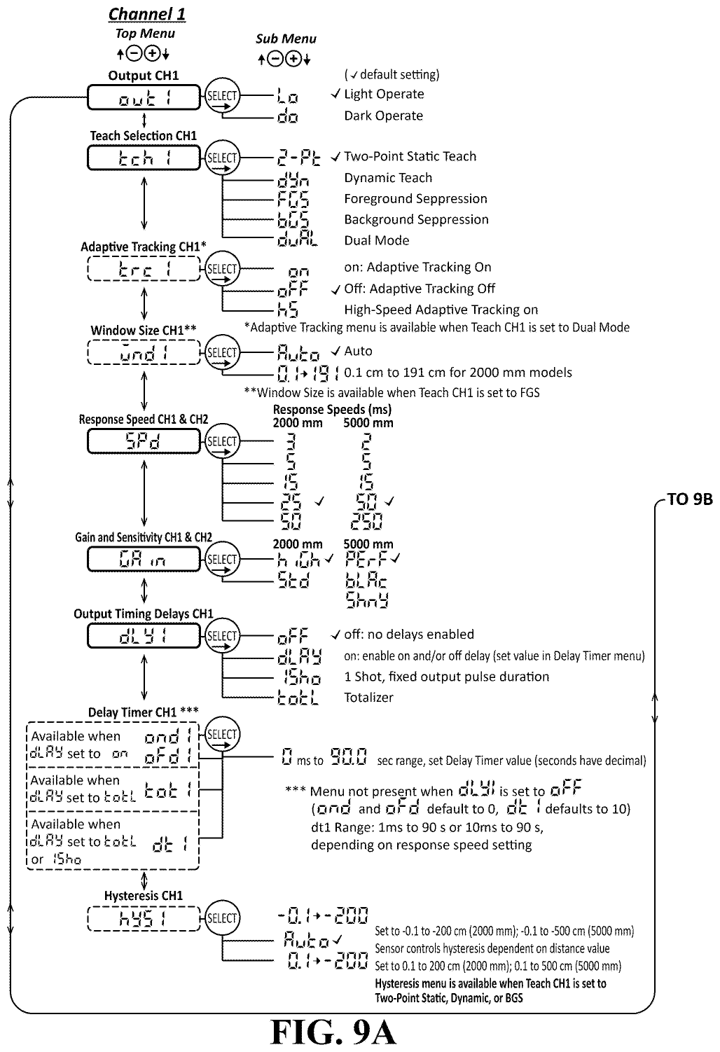

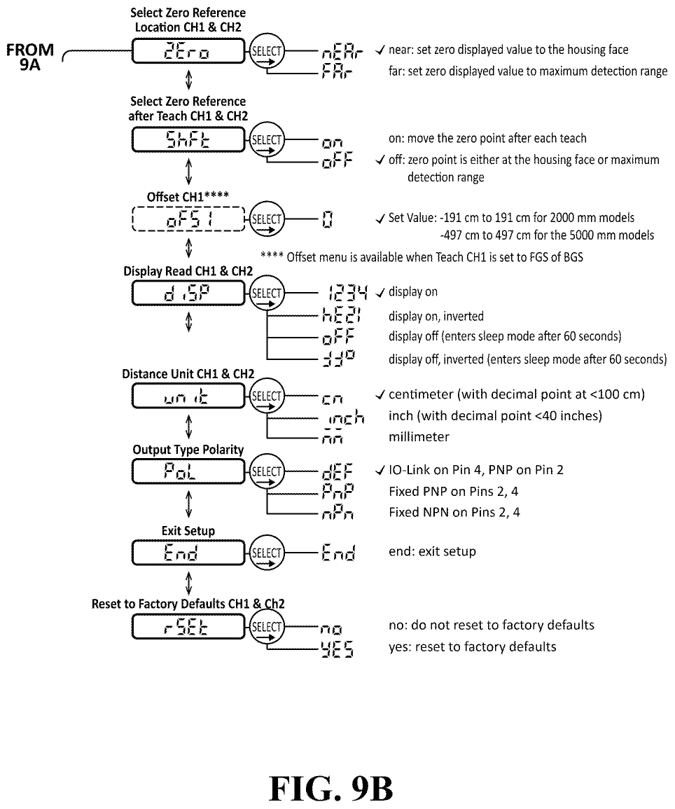

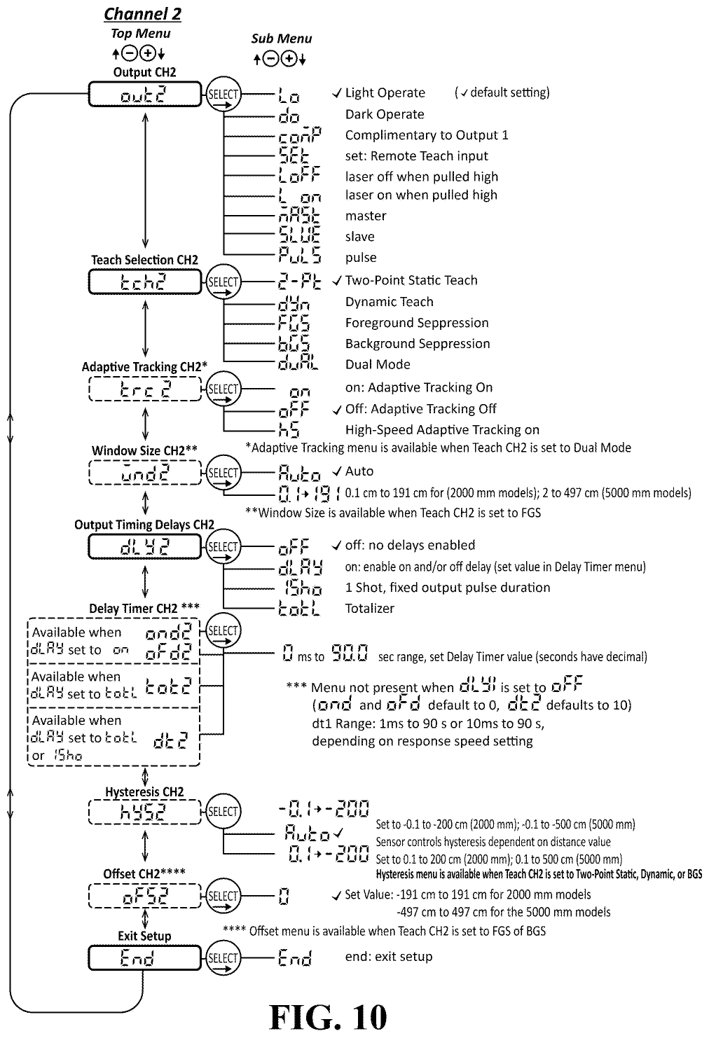

FIG. 9A and FIG. 9B depict an exemplary user interface interaction process to field-adjust a first channel of an exemplary SDGMS. FIG. 10 depicts an exemplary user interface interaction process to field-adjust a second channel of the exemplary SDGMS.

Although various embodiments have been described with reference to the figures, other embodiments are possible.

Although an exemplary system has been described with reference to the figures, other implementations may be deployed in other industrial, scientific, medical, commercial, and/or residential applications.

In some embodiments an emitter power may be adjustable. Such embodiments may, for example, advantageously reduce the light directly entering the APD. Such embodiments may, for example, have a less predictable current to wattage curve of the emitter at low values. Furthermore, if a monitor photodiode is used, its signal level may also be reduced. Fundamental limits may, for example, exist on a high side of emitter power. For example, the emitter element itself may have a physical limit on peak power. That limit may, for example, be lower at a higher temperature(s) where the sensor may operate at. Operating the emitted power higher may, for example, also be limited by laser class restrictions and/or FDA light limits.

In some embodiments circuit gain may be adjustable. For example, TIA gain may provide a good signal to noise ratio. However, making TIA gain adjustable may, for example, be difficult. A gain range achievable by TIA gain adjustment may, for example, be limited. In various embodiments, op-amp based gain stages may be implemented to adjust circuit gain. In some embodiments, circuit bandwidth and/or RMS noise levels may be changed when this gain is adjusted. High gain and high signal bandwidth may, for example, be difficult to achieve simultaneously (e.g., with op-amp based gain stages, with circuit gain adjustment).

In some embodiments, integration time may, for example, be adjustable. Some embodiments, for example, may integrate a circuit and/or light receiving element (such as a CMOS pixel). In such embodiments, the exposure time may, for example, be adjusted to change gain. Longer exposure time may correspond to increased collection of ambient light, which may add noise to signal measurements.

In some embodiments optics may, for example, be adjusted. An effective clear aperture of an optics system may, for example, be adjusted to control an amount of light received. Such embodiments may, for example, increase mechanical complexity. Some embodiments may, for example, increase response time.

Some sensor embodiments may, for example, be provided with separate fixed hardware and/or optical configurations. Different configurations may, for example, be supplied as separate sensors (e.g., different models). Different configurations may, for example, be separately optimized for different operating modes. For example, a first configuration may be optimized for a range of dark targets (less light received). A second configuration may, for example, be optimized for a range of bright targets (more light received). Accordingly, such embodiments may require a customer to purchase different configurations for different applications. Such embodiments may, for example, require sensors to be replaced and/or multiple different configurations installed in order to monitor a desired range of targets having a (wide) range of reflectivity. Various embodiments may advantageously provide a gain adjustment for an APD, while keeping a single sensor model and hardware configuration.

In various embodiments circuit gain mode changes, such as adjusting APD voltage, may also change characteristics that affect how accurate a system is (for instance, if a sensor is measuring distance using light, a change may alter how accurate the distance measurement is). Naïve systems may, for example, adjust gain parameters without adjusting compensations for measurement accuracy.

A control parameter for a circuit gain mode change (e.g., a voltage value, a current value) may vary with temperature. Naïve systems may, for example, not account for this. Such systems may, for example, have a gain which is not consistent over a wide temperature range.

APDs may, for example, be used for time-of-flight (TOF) principle distance measurement systems. In TOF systems, the amplitude of the signal as measured by the photodiode may be directly related to the accuracy of the distance measurement. Changes in gain levels may, for example, shift timing of the signal. A shape of the signal (e.g., how quickly a leading edge pulse rises, how strong a leading edge pulse is), may affect the measured time of the signal. Changes on the order of 67 picoseconds may, for example, represent 1 cm of distance error. Changes on the order of 6.7 ns may, for example, represent 1 meter of distance error. Various embodiments may provide control over an electrical gain path and signal amplitudes. Such embodiments may, for example, advantageously provide control critical to achieving a desired and/or required distance measurement accuracy (e.g., 1 cm level accuracy). Various embodiments may, for example, advantageously allow gain adjustments to be made while maintaining measurement accuracy.

Various embodiments may apply one or more measurement principles. Various measurement principles may, for example, be affected by gain adjustment and/or dynamic range. Some embodiments may be configured to measure distance, for example, by a triangulation principle. Some embodiments may be configured to measure light intensity (e.g., correlated to distance).

Various embodiments may be configured to communicate via one or more communication protocols. For example, in some embodiments a SDGMS may be configured to transmit an output signal(s) to a controller. The SDGMS may, for example, be configured to generate output signal(s) in at least one communication protocol including, by way of example and not limitation, IO-Link, Modbus, ProfiNet, ethernet, serial communication, or some combination thereof. In some embodiments a SDGMS may be configured to receive input signal(s) from a controller. The SDGMS may, for example, be configured to receive input signal(s) in at least one communication protocol including, by way of example and not limitation, IO-Link, Modbus, ProfiNet, ethernet, serial communication, or some combination thereof. For example, user input may be received from a remote device via the at least one communication protocol. The user input may, for example, include a signal(s) indication selection of a gain mode. In some embodiments the gain mode may, for example, be selected automatically by a device (e.g., a controller) based on predetermined criterion. For example, the gain mode may be selected based on a type of objects being detected. The gain mode may, for example, be selected based on a schedule (e.g., shiny objects are run on Mon-Tue, and cardboard boxes are run on Wed-Fri). Accordingly, some embodiments may advantageously selectively control gains of multiple sensors across a network.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a 9V (nominal) battery, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, Modbus, IO-Link, serial communication, USB 2.0, Firewire, ATA/IDE, RS-232, RS-422, RS-485, 802.11a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a method may increase dynamic range in an optical measurement sensor. The method may include providing user selection of APD gain mode, where the user can choose between two or more gain modes. The gain mode may be consistent over an operating temperature range. The measurement may be offset based on the gain mode (e.g., to maintain accuracy).

The method may further include automatic gain control via additional circuit control of emitter current. The method may include automatic gain control via at least one TIA. The method may include automatic gain control via at least one op-amp gain switch. The method may include automatic gain control via a combination of the at least one TIA and the at least one op-amp gain switch. In some embodiments the method may omit the at least one TIA and/or the at least one op-amp gain switch.

The automatic gain may, for example, be consistent over the operating temperature range. The measurement may be offset based on circuit gain settings (e.g., to maintain accuracy).

The user gain selection may, for example, be performed by a user interacting with an LED display. The user gain selection may, for example, be performed by a user interacting with an LCD display. The user gain selection may, for example, be performed by a user interacting with a button user interface on a sensor. The user gain selection may, for example, be communicated via JO-Link. The user gain selection may, for example, be communicated via serial communication.

In an illustrative aspect, a field selectable gain mode sensor may include a user interface configured to receive a user selection from multiple predetermined user selectable gain modes. The sensor may include a controller circuit operably coupled to the user interface to receive the user selection of the predetermined user selectable gain modes and determine a corresponding set of independent gain parameters. The sensor may include multiple gain stages operably coupled to the controller circuit, including a circuit gain control circuit, an emitter gain control circuit, and an APD gain control circuit. When the user selectable gain mode is selected, the controller circuit may: apply the independent gain parameters corresponding to the selected user selectable gain mode to the multiple gain stages, and generate a measurement offset profile based on the user selectable gain mode profile. The measurement offset profile may include: an offset configured to be applied to a distance measurement as a function of the emitter gain offset, the APD gain offset, the circuit gain offset, and environmental parameters including ambient temperature and ambient light. Accordingly, for example, a target accuracy of the distance measurement may be maintained independent of the selected gain mode, and a dynamic gain range is provided.

The multiple predetermined user selectable gain modes may be generated based on at least one calibration profile. The calibration profile may include a temperature calibration profile. The calibration profile may include an accuracy calibration profile. The sensor may include a lookup table storing predetermined parameters such that, for each of the user selectable gain mode profile, a set of independent gain parameters are generated corresponding to each of the circuit gain control circuit, the emitter gain control circuit, and the APD gain control circuit.

The sensor may be configured such that, upon receiving the user selection to switch from a first user selectable gain mode to a second user selectable gain mode such that a set of updated independent gain parameters is to be applied to the multiple gain stages, the controller circuit applies, for each of the updated independent gain parameters in the second user selectable gain mode, the updated independent gain parameter only if the updated gain parameter is different from a corresponding original independent gain parameter.

The independent gain parameters may include a range of control voltage.

The independent gain parameters may include a range of control current.

The independent gain parameters may include a range of gain selection input.

At least one of the multiple predetermined user selectable gain modes may be generated based on a measured environmental parameter.

When the field selectable gain mode sensor is operating in a user selectable gain mode, the controller circuit may be configured to dynamically adjust independent gain parameters within a predetermined range.

The circuit gain control circuit may include a trans-impedance amplifier.

In an illustrative aspect, a field selectable gain mode sensor may include a user interface configured to receive a user selection from multiple predetermined user selectable gain modes. The sensor may include a controller circuit coupled to the user interface to receive the user selection of the predetermined user selectable gain modes and determine a corresponding set of independent gain parameters. The sensor may include multiple gain stages operably coupled to the controller circuit. The multiple gain stages may include a circuit gain control circuit, an emitter gain control circuit, and an APD gain control circuit. When the user selectable gain mode is selected, the controller circuit may apply the independent gain parameters corresponding to the selected user selectable gain mode to the multiple gain stages, such that a target collective dynamic gain range is provided.

The multiple predetermined user selectable gain modes may be generated based on at least one calibration profile. The calibration profile may include a temperature calibration profile. The calibration profile may include an accuracy calibration profile. The sensor (e.g., the calibration profile) may include a lookup table storing predetermined parameters such that, for each of the user selectable gain mode profile, a set of independent gain parameters are generated corresponding to each of the circuit gain control circuit, the emitter gain control circuit, and the APD gain control circuit.

Upon receiving the user selection to switch from a first user selectable gain mode to a second user selectable gain mode such that a set of updated independent gain parameters is to be applied to the multiple gain stages, then the controller circuit may apply, for each of the updated independent gain parameters in the second user selectable gain mode, the updated independent gain parameter only if the updated gain parameter is different from a corresponding original independent gain parameter.

The independent gain parameters may include a range of control voltage.

The independent gain parameters may include a range of control current.

The independent gain parameters may include a range of gain selection input.

The controller circuit may generate a measurement offset profile based on the user selectable gain mode. The measurement offset profile may include: an offset being applied to a distance measurement as a function of the emitter gain offset; the APD gain offset; the circuit gain offset; and, environmental parameters which may include ambient temperature and ambient light such that, a high accuracy of the distance measurement is maintained independent of the selected gain mode.

At least one of the multiple predetermined user selectable gain modes may be generated based on a measured environmental parameter.

When the field selectable gain mode sensor is operating in a user selectable gain mode, the controller circuit may be configured to dynamically adjust independent gain parameters within a predetermined range.

The circuit gain control circuit may include a trans-impedance amplifier.

The multiple gain stages may include op-amp based gain stages.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A field selectable gain mode sensor, comprising:
a user interface configured to receive a user selection from a plurality of predetermined user selectable gain modes;
a controller circuit operably coupled to the user interface to receive the user selection of the predetermined user selectable gain modes and determine a corresponding set of independent gain parameters; and,
a plurality of gain stages operably coupled to the controller circuit, comprising a circuit gain control circuit, an emitter gain control circuit, and an APD gain control circuit,
wherein, when the user selectable gain mode is selected, the controller circuit:
applies the independent gain parameters corresponding to the selected user selectable gain mode to the plurality of gain stages, and,
generates a measurement offset profile based on the user selectable gain mode profile, wherein the measurement offset profile comprises:
an offset configured to be applied to a distance measurement as a function of the emitter gain offset, the APD gain offset, the circuit gain offset, and,
environmental parameters comprising ambient temperature and ambient light,
such that, a target accuracy of the distance measurement is maintained independent of the selected gain mode, and a dynamic gain range is provided.

2. The field selectable gain mode sensor of claim 1, further comprising a lookup table, wherein:
the plurality of predetermined user selectable gain modes is generated based on at least one calibration profile, the calibration profile comprising a temperature calibration profile and an accuracy calibration profile, and
the lookup table stores predetermined parameters such that, for each of the user selectable gain mode profile, a set of independent gain parameters are generated corresponding to each of the circuit gain control circuit, the emitter gain control circuit, and the APD gain control circuit.

3. The field selectable gain mode sensor of claim 1, wherein:
upon receiving the user selection to switch from a first user selectable gain mode to a second user selectable gain mode such that a set of updated independent gain parameters is to be applied to the plurality of gain stages,
the controller circuit applies, for each of the updated independent gain parameters in the second user selectable gain mode, the updated independent gain parameter only if the updated gain parameter is different from a corresponding original independent gain parameter.

4. The field selectable gain mode sensor of claim 1, wherein the independent gain parameters comprise a range of control voltage.

5. The field selectable gain mode sensor of claim 1, wherein the independent gain parameters comprise a range of control current.

6. The field selectable gain mode sensor of claim 1, wherein the independent gain parameters comprise a range of gain selection input.

7. The field selectable gain mode sensor of claim 1, wherein at least one of the plurality of predetermined user selectable gain modes are generated based on a measured environmental parameter.

8. The field selectable gain mode sensor of claim 1, wherein when the field selectable gain mode sensor is operating in a user selectable gain mode, the controller circuit is configured to dynamically adjust independent gain parameters within a predetermined range.

9. The field selectable gain mode sensor of claim 1, wherein the circuit gain control circuit comprises a trans-impedance amplifier.

10. A field selectable gain mode sensor, comprising:
a user interface configured to receive a user selection from a plurality of predetermined user selectable gain modes;
a controller circuit coupled to the user interface to receive the user selection of the predetermined user selectable gain modes and determine a corresponding set of independent gain parameters; and,
a plurality of gain stages operably coupled to the controller circuit, the plurality of gain stages comprising a circuit gain control circuit, an emitter gain control circuit, and an APD gain control circuit, wherein
when the user selectable gain mode is selected, the controller circuit applies the independent gain parameters corresponding to the selected user selectable gain mode to the plurality of gain stages, such that a target collective dynamic gain range is provided.

11. The field selectable gain mode sensor of claim 10, further comprising a lookup table, wherein:
the plurality of predetermined user selectable gain modes is generated based on at least one calibration profile, the at least one calibration profile comprising a temperature calibration profile and an accuracy calibration profile; and,
the lookup table stores predetermined parameters such that, for each of the user selectable gain mode profile, a set of independent gain parameters are generated corresponding to each of the circuit gain control circuit, the emitter gain control circuit, and the APD gain control circuit.

12. The field selectable gain mode sensor of claim 10, wherein:
upon receiving the user selection to switch from a first user selectable gain mode to a second user selectable gain mode such that a set of updated independent gain parameters is to be applied to the plurality of gain stages,
then the controller circuit applies, for each of the updated independent gain parameters in the second user selectable gain mode, the updated independent gain parameter only if the updated gain parameter is different from a corresponding original independent gain parameter.

13. The field selectable gain mode sensor of claim 10, wherein the independent gain parameters comprise a range of control voltage.

14. The field selectable gain mode sensor of claim 10, wherein the independent gain parameters comprise a range of control current.

15. The field selectable gain mode sensor of claim 10, wherein the independent gain parameters comprise a range of gain selection input.

16. The field selectable gain mode sensor of claim 10, wherein the controller circuit generates a measurement offset profile based on the user selectable gain mode,
wherein the measurement offset profile comprises:
an offset being applied to a distance measurement as a function of the emitter gain offset;
the APD gain offset;
the circuit gain offset; and,
environmental parameters comprising ambient temperature and ambient light such that, a high accuracy of the distance measurement is maintained independent of the selected gain mode.

17. The field selectable gain mode sensor of claim 10, wherein at least one of the plurality of predetermined user selectable gain modes is generated based on a measured environmental parameter.

18. The field selectable gain mode sensor of claim 10, wherein when the field selectable gain mode sensor is operating in a user selectable gain mode, the controller circuit is configured to dynamically adjust independent gain parameters within a predetermined range.

19. The field selectable gain mode sensor of claim 10, wherein the circuit gain control circuit comprises a trans-impedance amplifier.

20. The field selectable gain mode sensor of claim 10, wherein the plurality of gain stages comprises op-amp based gain stages.
